(19) United States
(12) Patent Application Publication
(10) Pub. No.: US 2008/0137564 A1
(43) Pub. Date: Jun. 12, 2008

(54) Data Transmission System

(75) Inventor: Christoph Herrmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/533,716

(22) PCT Filed: Nov. 8, 2003
(86) PCT No.: PCT/IB03/04958

§ 371 Date: May 3, 2005

(30) Foreign Application Priority Data
Nov. 8, 2002 (DE) 10252536.6

(51) Int. Cl. H04B 7/00

(52) U.S. Cl. 370/310

(57) ABSTRACT

In order to minimize the overall delay when transmitting data via the HS-DSCH in UMTS, provisions should be made that an RLC entity on the UE side receives RLC PDUs carried by the HS-DSCH as early as possible from the MAC-hs layer, while at the same time keeping the right sequence of these RLC PDUs. In accordance with the present invention, the scheduler in Node B is allowed to send a list of TSNs of MAC-hs PDUs which are still under retransmission to the receiver, such as a mobile station. Such a list may also be sent for MAC-hs PDUs for which the transmission was aborted but a new transmission is intended. Advantageously, this may allow to avoid “useless gaps” in a reordering buffer of the receiver and, as such, may allow for an efficient data transmission.

The present invention relates to an exchange of data between a transmitter and a receiver in a data transmission system, such as UMTS. In particular, the present invention relates to a method of transmitting data from a transmitter to a receiver, to a data transmission system for transmitting data from a transmitter to a receiver, to a transmitter for transmitting data to a receiver, to a receiver for receiving data transmitted from a transmitter and to a software program for controlling a data transmission between a transmitter and a receiver.

A transmission system for transmitting data packets between a transmitter and a receiver is, for example, described in 3 GPP TS 25.308 V5.2.0 (2002-03), Technical Specification, 3^{rd} Generation Partnership Project; Technical Specification Group Radio Access Network; High Speed Downlink Packet Access (HSDPA); Overall description; Stage 2 (Release 5) and 3 GPP TS 25.321 V5.2.0 (2002-09) Technical Specificaion 3rd Generation Partnership Project; Technical Specification Group Radio Access Network; MAC protocol specification (Release 5), which are both incorporated by reference.

In such known data transmission in UMTS, in order to minimize the overall delay when transmitting data via the HS-DSCH (high speed downlink shared channel), a reordering window for each priority class in the MAC-hs layer is known, which may allow that an RLC entity on a UE (user equipment denoting, for example, a mobile station) site, receive RLC PDUs, carried in a MAC-hs PDU via the HS-DSCH in many cases as early as possible from the MAC-hs layer, while, at the same time keeping the right sequence of these RLC-PDUs.

However, in spite of the provision of the reordering window described in the above indicated technical specifications, it may occur that MAC-hs SDUs (service data units) unnecessarily wait in a reordering buffer of the priority class at the receiving side. This may introduce an unnecessary or unwanted delay in the data transmission.

The technique described here is explained by means of the term priority class, which is used in the cited 3GPP specifications. This does not restrict to apply the technique to any type of different streams or flows or channels, over which packet data is sent, no matter whether they are prioritized among each others or not. The essential characteristic is that the packets of the same stream, flow, channel, or priority class are indicated as belonging to the same stream, flow, channel, or priority class, which is typically done by means of a stream-identifier, flow-identifier, channel-identifier or priority class identifier in the packet header.

It is an object of the present invention to provide for an improved data transmission.

According to an exemplary embodiment of the present invention as set forth in claim 1, the above object may be solved by a method of transmitting data from a transmitter to a receiver. The data is segmented into a plurality of first data packets. The plurality of first data packets is respectively provided with a transmission sequence number. For at least one second data packet of the plurality of first data packets, which cannot be decoded error-free at the receiving side, a retransmission is performed. According to an aspect of this exemplary embodiment of the present invention, a third data packet is transmitted from the transmitter to the receiver, including information with respect to the at least one second data packet. In particular, this information may relate to which of the at least one second data packet is at least partly sent again from the transmitter to the receiver.

In other words, the transmitter sends information to the receiver relating to which of the at least one second data packet is at least partly sent again from the transmitter to the receiver. This “sending again” may relate to a retransmission or to a completely new transmission of this at least one second data packet.

Furthermore, the expression “retransmission for a data packet” is used here in order to state that the retransmitted bits do not necessarily form an exact copy of the bits which were sent in the initial transmission of the packets. Instead these bits can just represent e.g. punctured bits, which were not sent in the initial transmission. This is known in the literature as non-self-decodable redundancy. In this document, the term “a packet is partly retransmitted” is used to express that non-self-decodable redundancy is used in the retransmission. In this sense, saying that “a packet is at least partly sent again” includes that either non-self-decodable or self-decodable redundancy is retransmitted, which also includes the retransmission of an exact copy of the initial transmission.

Advantageously, due to the fact that after receiving this information, the receiving side “knows” for which of the at least one second data packets a further transmission is to be expected. Data at the receiving side relating to second data packets, for which no further transmission is to be expected may now be further processed or deleted without further waiting. This may allow to reduce delays in the data transmission from the transmitter to the receiver.

According to another exemplary embodiment of the present invention as set forth in claim 2, a method is provided which may, for example, be performed in a UMTS telephone or data transmission system. According to this exemplary embodiment of the present invention, the information indicates to the receiver, for which of the at least one second data packet a negative acknowledgement message was received and/or for which of the at least one second data packet, the retransmission of which has been aborted, and new transmission is scheduled. Advantageously, this may allow to avoid delays in the transmission of the data from the transmitter to the receiver. In particular, information for which of the second data packets, the retransmission of which has been aborted, a new transmission may be expected, may, for example, be advantageous in situations where, for example, the scheduler in a UMTS node B or base station, which controls the operation of the HARQ process as described in the above cited references interrupts a transmission of data packets having a low priority for transmitting data packets having a higher priority.

According to another exemplary embodiment of the present invention as set forth in claim 3, a list is generated, for example, at the time of a generation of the information to be sent to the receiver. This list may contain a list of transmission sequence numbers of data packets for which a negative acknowledgement message has been received, or for which a new transmission is planned. This may be done for each class of priorities. The transmission sequence numbers (TSNs) in this list may be denoted as “Still-NACK'ed-or-to-Reinitiate retransmission-Indication” (SNRI).

According to another exemplary embodiment of the present invention as set forth in claim 4, the information may be sent in the data packet which is next to be transmitted to the receiver, in a data packet provided with a header and/or in a data packet exclusively containing the information and not containing payload data.

For example, to contain the information in the header of the data packet may provide for a simple and efficient transmission of the information to the receiver. On the other hand, the transmission of the information in a data packet exclusively transmitting the information, may provide for a very secure transmission of the information especially in case of the UMTS High Speed Downlink Shared Channel (HS-DSCH), since such a data packet may, due to the relatively low amount of bits to be transmitted, have a very high probability of a successful receipt, since with the transport block sizes defined for the HS-DSCH, the forward error correcting is extremely strong (code rate 1/7).

According to another exemplary embodiment of the present invention as set forth in claim 5, the receiver purges all holes provided for data packets for which no successful decoding has been performed, except for those for which a further transmission (new transmission or retransmission) is indicated by the information. Due to this, a considerable amount of data buffered in the receiver except for data packets indicated by the information and possibly some others, may be further processed, i.e. handed to a higher layer, or may be deleted in the buffer. By this, a very efficient data transmission may be provided and delays may be avoided.

According to another exemplary embodiment of the present invention as set forth in claim 6, the transmitter sends the information, for example, when the transmitter (which may be associated with the scheduler, for example, in UMTS) interrupts a transmission of data packets because of a transmission to another receiver and/or because of a transmission having a higher priority to another receiver and/or the interruption takes longer than a preset time.

According to another exemplary embodiment of the present invention as set forth in claim 7, a data transmission system is provided for transmitting data from a transmitter to a receiver. According to an aspect of this exemplary embodiment of the present invention, information is sent from the transmitter to the receiver relating to for which data packet, which has not been successfully decoded at the receiver, a new transmission or retransmission is planned or scheduled by the transmitter.

Advantageously, this data transmitting system may allow for an efficient and fast end-to-end data transmission, where a delay in the data transmission may be avoided or minimized.

Exemplary embodiments of the data transmission system according to the present invention are provided in claims 8 and 9.

According to another exemplary embodiment of the present invention as set forth in claim 10, a transmitter is provided which is adapted to transmit information to the corresponding receiver. This information indicates to the receiver, which of the data packets which have not yet been successfully decoded at the receiver are retransmitted, i.e. for which of these data packets a retransmission or a completely new transmission is planned or scheduled.

Exemplary embodiments of the transmitter according to the present invention are provided in claims 11 to 14.

According to another exemplary embodiment of the present invention as set forth in claim 15, a receiver is provided, which is adapted to receive information with respect to a retransmission or new transmission of data packets, which have not been successfully decoded by the receiver.

Exemplary embodiments of the receiver according to the present invention are, for example, provided in claims 16 and 17.

According to an exemplary embodiment of the receiver according to the present invention as set forth in claim 18, the receiver comprises a reordering buffer and the receiver is adapted to, upon receipt of the information, purge holes provided or kept for data packets for which no successful decoding has yet been performed, except for such data packet indicated by the information.

Advantageously, this may allow to avoid that data relating to data packets for which no further transmission or retransmission is to be expected, is no longer kept in the reordering buffer unnecessarily. This may allow for a fast further processing of such data.

According to another exemplary embodiment of the present invention, a computer program is provided for controlling a data transmission between a data transmitter and a receiver of, for example, a UMTS data or speech transmission system. The computer program may be written in any suitable programming language, such as C++ and may be stored on a computer readable device, such as a CD-ROM. However, the computer program according to the present invention may also be presented over a network such as the WorldWideWeb, from which it may be downloaded into, for example, a working memory of a data processor of a transmitter or a receiver.

It may be seen as the gist of an exemplary embodiment of the present invention that the transmitter is adapted to send, for example, as a part of a data packet, a list of transmission sequence numbers of data packets, for which negative acknowledgement messages have been received earlier, which are still under retransmission (for example, with applying a soft combining method at the receiving side) or for which the transmitter (triggered or associated with for example, the scheduler in the Node B, which scheduler controls data transmission via the HS-DSCH in the UMTS) intends to re-initiate transmission (i.e. no soft combining with the data conveyed in earlier transmission attempts). This may allow to avoid a delay in data transmission and may allow for an efficient data transmission.

These and other aspects of the present invention will become apparent from and elucidated with reference to the embodiments described hereinafter.

Exemplary embodiments of the present invention will be described in the following, with reference to the following drawings:

FIG. 1 shows simplified representation of a data transmission system or speech transmission system according to an exemplary embodiment of the present invention.

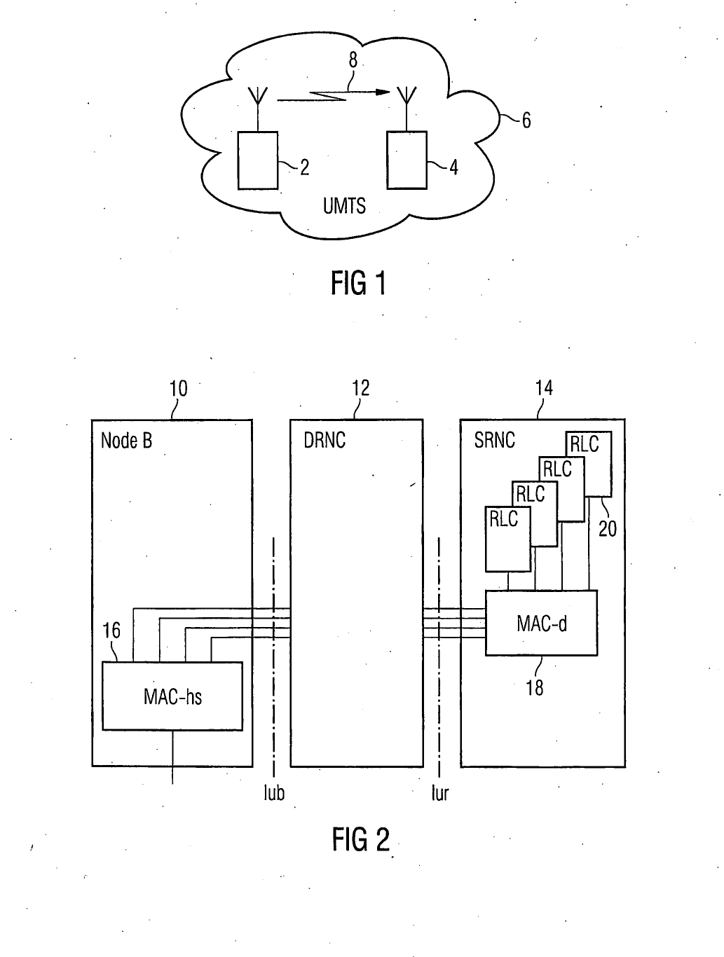

FIG. 2 shows an exemplary embodiment of a layer structure realized in the data transmission system according to the present invention depicted in FIG. 1.

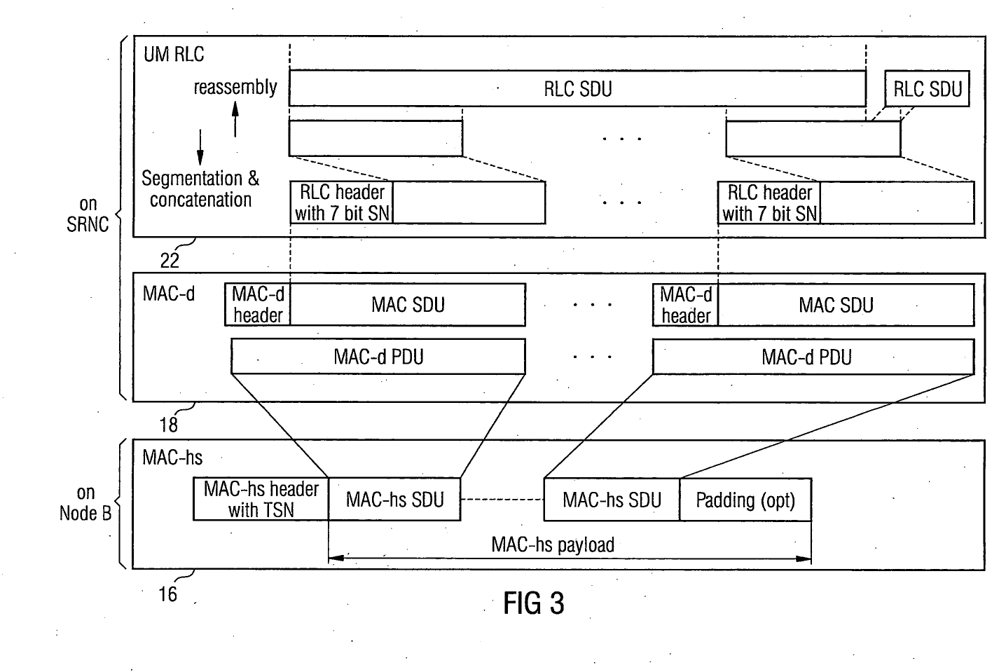

FIG. 3 shows a simplified representation of layers and data packets as used and/or implemented in the transmitter or receiver of the data transmission system depicted in FIG. 1.

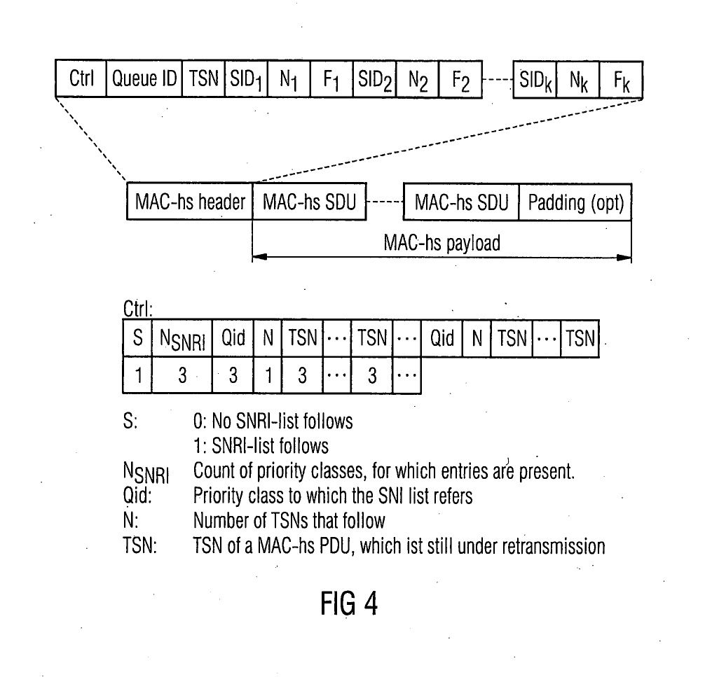

FIG. 4 shows a simplified representation of a first exemplary embodiment of a data packet according to the present invention.

In the following, the present invention is described in further detail with respect to a UMTS system as, for example, described in 3 GPP TS 25.308 V5.2.0 (2002-03), Technical Specification, 3^{rd} Generation Partnership Project; Technical Specification Group Radio Access Network; High Speed Downlink Packet Access (HSDPA); Overall description; Stage 2 (Release 5) and 3 GPP TS 25.321 V5.2.0 (2002-09) Technical Specificaion3rd Generation Partnership Project; Technical Specification Group Radio Access Network; MAC protocol specification (Release 5), which are both hereby incorporated by reference. However, it should be noted that the present invention is not limited to UMTS.

FIG. 1 shows a simplified representation of a UMTS data transmission system according to an exemplary embodiment of the present invention. As may be taken from FIG. 1, the UMTS system 6 comprises a transmitter 2 and a receiver 4. Data is transmitted from the transmitter 2 via an air interface 8 to a receiver 4. The air interface may comprise a plurality of radio channels.

FIG. 2 shows a simplified representation of elements which may be comprised in the transmitter 2 and/or in the receiver 4 of the data transmission system depicted in FIG. 1. The reference numeral 10 designates a Node B, as, for example, described in the above technical specifications. As may be taken from FIG. 2, between Node B 10 and a DRNC 12 (drift radio network controller), there is provided a first interface Iub and between the DRNC 12 and the SRNC 14 (serving RNC), there is provided another interface (Iur). RNC refers to a radio network controller.

As may be taken from FIG. 2, the MAC-hs entity 16 is located on the Node B 10. The MAC-hs is the medium access control for the HS-DSCH (high speed downlink shared channel).

The MAC-hs entity 16 is connected via Iub and Iur to the MAC-d entity 18, which in turn is connected to a plurality of RLC (radio link control) machines 20.

FIG. 3 shows a simplified representation of a communication taking place between the MAC-d entity 18 and the MAC-hs entity 16. Furthermore, there is shown a communication stream between a UM (unacknowledged mode) RLC entity 22 and the MAC-d entity 18. As mentioned before, the UM RLC entity 22 and the MAC-d 18 are both located on the SRNC and the MAC-hs is located on the Node B.

For a further explanation and description of details with respect to the communication and/or construction and implementation of the RLCs 20 and 22, the MAC-d 18 and the MAC-hs 16, reference is made to 3 GPP TS 25.308 V5.2.0 (2002-03), Technical Specification, 3^{rd} Generation Partnership Project; Technical Specification Group Radio Access Network; High Speed Downlink Packet Access (HSDPA); Overall description; Stage 2 (Release 5) and 3 GPP TS 25.321 V5.2.0 (2002-09) Technical Specificaion3rd Generation Partnership Project; Technical Specification Group Radio Access Network; MAC protocol specification (Release 5), which are both hereby incorporated by reference.

In the following, the description is focused on aspects of such a system relating to the present invention.

The data transmission described in the above technical specifications provides for a data transmission via the HS-DSCH.

A scheduler in the base station or Node B (which scheduler is not shown in FIGS. 1 to 3), in particular the MAC-hs layer in this base station or Node B, is adapted to send data in the form of data packets via up to eight so-called HARQ processes (HARQ: hybrid automatic repeat request) to a user equipment (UE) such as a receiver or a mobile station. In the above mentioned 3GPP specifications, the term HARQ process is used to denote one instance of a HARQ stop-and-wait protocol. This means that this entity spans from the transmitting side on the Node B (and sends a data packet (MAC-hs PDU)), to the receiving side on the UE, where the received data packet has to be soft-combine with the already received soft-bits of the same data packet, which are stored in a specific soft-buffer. There is a one-to-one mapping between the HARQ process identifier, which is sent via the HS-SCCH (High Speed Shared Control Channel), and the address of the soft-buffer, which contains soft-bits of earlier transmissions of the same data packet or MAC-hs PDU.

The data packets sent from the so-called MAC-hs layer of the transmitter are referred to as MAC-hs PDUs (MAC-hs protocol data unit) since they are handed from the MAC-hs layer to an underlying physical layer for transmission via the radio path, i.e. the radio interface. As may be taken, for example, from FIG. 3, the MAC-hs PDUs are made from MAC-hs SDUs (service data units), which the MAC-hs layer 16 receives from the overlying layer. A receiver, such as a mobile station, which is supposed to receive data via the HS-DSCH is not permanently listening to the HS-DSCH, instead, this receiver listens permanently to up to 4 HS-DSCHs (high speed shared channel control channels) via which the receiver is informed
whether the next slot on the HS-DSCH contains a MAC-hs PDU addressed to this receiver
on which CDMA codes (code division multiple access) this MAC-hs PDU is sent and
for which HARQ process of the receiver this MAC-hs-PDU is supposed to be.

Each HARQ process has its own stop and wait protocol for the control of retransmissions of data packets (here MAC-hs PDUs), which have not been successfully decoded by the respective receiver (mobile station). For example, the HARQ process 1, sends a MAC-hs PDU via the HS-DSCH to the receiver and is then waiting for an acknowledgement message of the receiver (mobile station), indicating whether the MAC-hs PDU has been decoded error-free or not. A positive acknowledgement message, indicating that decoding was error-free is abbreviated as ACK. For the case that the mobile station was not able to decode the respective data packet error-free, the mobile station sends a negative acknowledgment message, abbreviated as NACK, to the transmitter.

In case the transmitter receives an ACK, the HARQ process I may continue with the transmission of the following MAC-hs PDU. In case an NACK is received by the transmitter, a scheduler (the transmitter) may, on one hand, perform a retransmission for this data packet. A retransmission for this data packet may be a complete retransmission of an identical data packet or may be a transmission of data relating to this unsuccessfully decoded data packet, i.e. not an exact copy of the originally sent data packet. Thus, such retransmissions may contain a self-decodable incremental redundancy or a none self-decodable incremental redundancy. In both cases, the mobile station uses the resent data, i.e. the data included in the resent data packets, together with the data contained in the originally sent data packet, which could not be decoded error-free, for achieving a better decoding result. This may be referred to as soft combining. On the other hand, the scheduler (transmitter) may also decide to abort the transmission and/or retransmission of this original MAC-hs PDU because of the unsuccessful decoding, for example, the scheduler may decide to abort transmission of this MAC-hs PDU because of the fact that the preset number of retransmissions has been reached.

As long as a HARQ process is busy with performing retransmissions, the data transmission on this process is in a stall or is blocked since only the retransmission can be sent. For this reason, the data transmission via the HS-DSCH is performed on a plurality of HARQ processes, in a time-division fashion. Due to the fact that only a few of the up to eight HARQ processes are normally blocked by retransmissions, a continuous stream of data may usually be generated, i.e. transmitted between the transmitter and the receiver. Thus the sequence of the MAC-hs PDUs, which are to be transmitted via the HS-DSCH are subsequently distributed onto a plurality of HARQ processes. As soon as a HARQ process has received an ACK with respect to an earlier sent data packet, a new data packet, i.e. a new MAC-hs PDU may be transmitted.

Due to the distribution of MAC-hs PDUs which are actually to be sent one after the other onto a plurality of HARQ processes, which send these MAC-hs PDUs completely independently of each other in accordance with a known stop-and-wait protocol to the receiver, it may occur that the order or succession of these MAC-hs PDUs received at the receiver, is different to the order or succession which they originally had. In order to reestablish this order or succession, the MAC-hs PDUs are provided with a numbering (transmission sequence number, TSN) in the header of each MAC-hs PDU. Also, a buffer (reordering buffer) is provided in the receiver, allowing for buffering of MAC-hs PDUs in order to reestablish the original and/or correct order or succession. The receiver is always waiting for a MAC-hs PDU with a particular TSN as the next MAC-hs PDU (Next_expected).

In case the receiver is not able to receive or decode a MAC-hs PDU with exactly this TSN but receives another MAC-hs PDU with another TSN which indicates that this MAC-hs PDU has been sent later with respect to the missing MAC-hs PDU, all the MAC-hs PDUs which are already buffered in the reordering buffer, have to wait until the MAC-hs PDUs are handed to the subsequent layer for further processing. Only when the missing MAC-hs PDU (Next_expected_TSN) has been successfully, i.e. error-free decoded, may the MAC-hs SDUs of all MAC-hs PDUs which have been waiting in the reordering buffer without a gap or hole in the sequence, be handed to the RLC (radio linked control) layer. The RLC layer controls the segmentation and retransmission on the mobile station and the radio network controller (RNC).

After that, the variable Next_expected_TSN is then set to the value of the TSN of the MAC-hs PDU, which is expected after the last MAC-hs PDU has been received, from which the MAC-hs SDUs contained therein are handed to the RLC layer.

A variety of reasons may cause that a MAC-hs PDU is not successfully sent to the receiver (for example, the mobile station), which may cause a gap or hole in the reordering buffer:
The base station misinterprets an NACK sent for a MAC-hs PDU from the receiver due to unfavorable general conditions in the up-link as ACK and therefore assumes that the receiver does not need a retransmission for this particular MAC-hs PDU. This is usually referred to as NACK>ACK misinterpretation.
The base station decides to abort a transmission or retransmission of this MAC-hs PDU. Such a decision may, for example, be taken when the MAC-hs PDU is too old, i.e. when such MAC-hs PDU may have no use for the receiving side.

In order to avoid that due to the missing MAC-hs PDUs, other MAC-hs PDUs remain for a long time in the reordering buffer, a reordering timer and a reordering window may be applied as follows:

In case the reordering timer for the next MAC-hs PDU to be received lapses before this particular MAC-hs PDU is received, this particular MAC-hs PDU is considered as received and thus all MAC-hs PDUs waiting, in the reordering buffer, without a gap or hole behind this missing MAC-hs PDU are handed to the RLC layer. After that, the reordering timer is restarted for the next MAC-hs PDU to be received. Usually, the reordering timer is set to a high value in order to allow that, for example, other mobile stations are served via the HS-DSCH, wherein the transmission of the missing MAC-hs PDU in the reordering buffer of a considered mobile station may then be performed later on when the scheduler is again serving this particular mobile station such that gaps in the reordering buffer of this particular mobile station do not exist for a long time.

In contrast, the reordering window serves to indicate to the receiver from a continuous data stream without long time distances between successive MAC-hs PDUs that a MAC-hs PDU expected in the reordering buffer next, which is missing, is not transmitted anymore. For this, it is provided that the reordering window is updated upon receipt of a MAC-hs PDU with a TSN which is outside of the reordering window, such that the upper border of this reordering window coincides with the TSN of this MAC-hs PDU. All MAC-hs PDU in the reordering buffer with TSNs which are outside of the reordering window are then, after the window update, given to the RLC layer. Then, the TSN of the MAC-hs PDU to be expected next is set to a TSN subsequent to the TSN at the lower border of the reordering window, for which no data packet has been received. This causes that the reordering window may only allow that MAC-hs PDUs, which have to wait in the reordering buffer due to a MAC-hs PDU missing in the reordering buffer, can finally be delivered to the RLC layer, when always a new MAC-hs PDU is successfully transmitted, the TSN of which causes that the reordering window is updated in the above described manner. Considering for example a size of 32 of the re-ordering window and a TTI-hs of 2 ms (TTI-hs: transmission time interval of the MAC-hs layer; the TTI indicates how long the transmission of a MAC-hs PDU may take on the basis of the bit rate supported by the physical layer), it may take approximately 64 ms until a gap or hole in the reordering buffer may be removed by the reordering window.

Considering a case where, for example, a NACK>ACK misinterpretation occurs and an interruption of a transmission to a particular receiver occurs and the transmitter continued to transmit data to another mobile station, such that the continuous data stream is interrupted, the MAC-hs PDUs are kept in the reordering buffer of the receiver, such as a mobile station, without the chance that after a restart of the transmission to the particular receiver, the missing MAC-hs PDUs may be delivered, since the reason for them being missing is the NACK>ACK misinterpretation.

According to an exemplary embodiment of the present invention, such a situation is avoided by transmitting information from the transmitter to the receiver, including information with respect to data packets which have not been successfully decoded by the receiver before. In particular, this information may relate to which of these unsuccessfully decoded data packets an at least partial resending may be expected. In other words, this information may tell the receiver which of these unsuccessfully decoded data packets (MAC-hs PDUs) are retransmitted or sent again from the transmitter to the receiver.

By this, means are provided, allowing that MAC-hs SDUs waiting (as part of MAC-hs PDUs) in the reordering buffer unnecessarily are handed to the RLC layer in such situations in which the reordering timer and the reordering window are not able to do so. Advantageously, by this, an end-to-end delay in the transmission may be minimized, since the RLC layer is informed about missing RLC-PDUs at an early stage, such that it may, for example, be possible to initiate a retransmission of the missing RLC-PDUs on the RLC level.

In particular, according to the present invention, it may be provided that the scheduler in the MAC-hs layer on the Node B may “tell” the receiver for which MAC-hs PDU at the time of the generation of such information, it is still intended to:
perform a retransmission; i.e. for which MAC-hs PDU a NACK has been received by the transmitter
for which MAC-hs PDU, the retransmission of which has been aborted, a new transmission is intended

In particular, the latter case relates to, for example, a situation where the scheduler aborts a transmission of a MAC-hs PDU having a lower priority for transmitting a MAC-hs PDU having a higher priority.

For this, at the time the information is generated, the scheduler generates for each class of priorities which should be contained in the information a list of respective TSNs of MAC-hs PDUs for which either a NACK has been received or for which the transmission has been aborted but a new transmission is intended. These TSNs in this list may be referred to as “Still-NACK'ed-or-to-Reinitiate-transmission-Indication” (SNRI).

According to an aspect of an exemplary embodiment of the present invention, this list may be sent as a part of a MAC-hs PDU to be transmitted next, independently, for example of a priority class of the MAC-hs SDUs contained therein. According to an exemplary embodiment of the present invention, the header of this MAC-hs PDU to be transmitted next may be extended such that this list is contained in the header. This list may also be provided with entries for priority classes other than that of this MAC-hs PDU.

According to another exemplary embodiment of the present invention, this list may also be transmitted from the transmitter to the receiver such as the mobile station with a MAC-hs PDU, which does not contain any MAC-hs SDU, i.e. does not contain any payload data. Advantageously, this may allow that due to the very low amount of bits to be then transmitted, the smallest transport block size, i.e. the smallest possible size of a data packet may be selected, which provides for a strong error-correcting coding and may be transmitted with QPSK, such that a successful transmission without a retransmission may be assumed with a high probability. Also, this may allow that this small MAC-hs PDU containing the list and no further payload data is transmitted with only a minimum delay and a reduced risk that this MAC-hs PDU is lost due to a NACK>ACK misinterpretation. According to this exemplary embodiment of the present invention, such a MAC-hs PDU not containing payload data but only containing the list, may be referred to as MAC-hs control PDU.

According to an exemplary embodiment of the present invention, such MAC-hs control PDUs may be realized as modifications of the header known, for example, from 3 GPP TS 25.308 V5.2.0 (2002-03), Technical Specification, 3^{rd} Generation Partnership Project; Technical Specification Group Radio Access Network; High Speed Downlink Packet Access (HSDPA); Overall description; Stage 2 (Release 5) and 3 GPP TS 25.321 V5.2.0 (2002-09) Technical Specification 3rd Generation Partnership Project; Technical Specification Group Radio Access Network; MAC protocol specification (Release 5), which are both hereby incorporated by reference.

FIG. 4 shows a first exemplary embodiment of the SNRI-list, as it might be incorporated as part of a MAC-hs PDU. The S-bit indicates, whether this MAC-hs PDU contains any SNRI-list, i.e. it may be contained in all MAC-hs PDUs. If it is e.g. set to 0 no SNRI-list follows, but the known MAC-hs header beginning with the “Queue ID” field follows directly after the S-bit. If the S-bit is set to 1, and SNRI-list follows. The first field N_{SNRI} of the SNRI-list indicates the number of priority classes, for which the list contains entries. Since 8 priority classes are defined, this field is coded with 3 bits. The following fields represent groups of fields, which group identifies the TSNs of MAC-hs PDUs of the considered priority class, for which retransmissions are still ongoing, or which the scheduler of the HARQ protocol intends to retransmit in the future. Hence, each group starts with a Qid-field, which indicates to which queue idea the following N TSNs refer to. The N-field after the Qid-field indicates the count N of TSNs that follow, and then N TSN-fields follow, which contain the TSN of these MAC-hs PDUs. N is coded with 3 bits in correspondence with the maximum of 8 HARQ processes, for which MAC-hs PDUs can be outstanding. After the N_{SRNI} groups of fields, the normal known MAC-hs header follows with the “Queue ID” field. For future control purposes, the Ctrl-field could be extended by an additional bit (E-bit) not shown in the figure. If this E-bit is set to 1, additional control information can then be inserted between the last SNRI-list and the current MAC-hs header.

If no data follows after the Ctrl field, the MAC-hs PDU would only be a MAC-hs Control PDU.

According to another exemplary embodiment of the present invention, this list, which may also be referred to as SNRI list, may be transmitted via the HS-HCCH with a very strong error correcting code, via respectively one TTI-HS for a particular class of priority. Since, however, due to the relatively low number of bits on the HS-SCCH, only one class of priority is accounted for, the information, i.e. the SNRI list would have to be subsequently transmitted in a plurality of TTI-HS for the classes of priority.

Upon receipt of the SNRI list for a particular class of priority, the receiver removes all gaps or holes in the reordering buffer except for those MAC-hs PDUs which are named in the SNRI list. A removal of these gaps or holes means that the receiver considers these missing MAC-hs PDUs as received and hands respective MAC-hs PDUs contained in the reordering buffer to an overlaying layer (i.e. the disassembly layer, which extracts the contained MAC-hs SDUs, and delivers them to the MAC-d layer, which extracts from each MAC-hs SDU the contained RLC PDU and delivers this to the RLC layer). Furthermore, upon receipt of the SNRI list, the variable Next_expected_TSN is set to the next MAC-hs PDU to be received.

The SNRI list may be sent from the transmitter to the receiver on a regular basis. However, according to an exemplary embodiment of the present invention, the SNRI list is sent to the receiver when the scheduler interrupts a data transmission to a particular receiver or mobile station. since another receiver or mobile station is to be served. In such a case, the reordering window is incapable of removing holes or gaps in the reordering buffer, since the data stream for all priority classes is interrupted.

According to another exemplary embodiment of the present invention, the SNRI list is sent when the scheduler interrupts a data transmission for data relating to a lower class of priorities in favor of a data transmission relating to a higher class of priority for a pre-set time, such that the reordering window for this particular lower class of priority may not remove holes or gaps in the respective reordering buffer. In such a case, it may be advantageous to transmit the SNRI list for this lower priority class, which stream has been interrupted, as a part of a MAC-hs PDU belonging to the higher class of priority, due to which the data transmission for this lower class of priority is interrupted.

Furthermore, according to another exemplary embodiment of the present invention, the SNRI list may be transmitted from the transmitter to the receiver when a transmission for a class of priority stops for a pre-set time, i.e. when a time distance between two successive MAC-hs PDUs exceeds a pre-set value and becomes, for example, bigger than 64 ms, i.e. longer than a time the reordering window would require in the case of a continuous data stream for removing holes or gaps in the reordering buffer.

In another exemplary embodiment of the present invention, the SNRI list, may be transmitted, whenever the MAC-hs PDU has to be filled with padding bits, if no SNRI list is included, so that the SNRI list just uses the space, which would otherwise be occupied by the padding bits, which are just needed to adjust the size of the MAC-hs PDU to the transport block size, which is chosen for the transmission.

1. Method of transmitting data from a transmitter to a receiver, wherein the data is segmented into a plurality of first data packets for transmission, wherein the plurality of first data packets is provided with a transmission sequence number, wherein a retransmission for at least one second data packet of the plurality of first data packets is performed in case the at least one second data packet was unsuccessfully decoded at the receiver, the method comprising the steps of: transmitting a third data packet from the transmitter to the receiver including information with respect to the at least one second data packet; and wherein the information relates to which of the at least one second data packet is at least partly sent again from the transmitter to the receiver.

2. The method of claim 1, wherein the receiver sends a negative acknowledge message to the transmitter for each of the at least one second data packets which was unsuccessfully decoded at the receiver; wherein the transmitter performs a retransmission for the at least one second data packet for which a negative acknowledgement message was received; wherein the transmitter aborts retransmission for the respective at least one second data packet after a preset number of unsuccessful retransmissions; wherein the information indicates to the receiver at least one of a first fact and a second fact; wherein the first fact indicates for which of the at least one second data packet a negative acknowledgement message was received; and wherein the second fact indicates for which of the at least one second data packet which retransmission has been aborted, a new transmission is scheduled.

3. The method of clam 2, wherein the transmitter generates a list at the time of a generation of the information; wherein the list contains the at least one second data packet and a priority information or a channel information with respect to this at least one second data packet; and wherein the list is sent as the information.

4. The method of claim 1, wherein the information is sent in one of a fourth, fifth and sixth data packet; wherein the fourth data packet is scheduled next to be transmitted to the receiver; wherein the fifth third data packet is provided with a header; wherein the information is included in the header; wherein the sixth data packet does not include payload data and thus, has a short length and thus a very strong forward error correction.

5. The method of claim 1, wherein, upon receipt of the information, the receiver purges in a reordering buffer all holes for seventh data packets of the plurality of first data packets for which no successful decoding has been performed except for the at least one second data packet indicated by the information.

6. The method of claim 1, wherein the transmitter sends the information to the receiver in at least one of a first case, a second case and a third case; wherein, according to the first case, the information is sent from the transmitter to the receiver when the transmitter interrupts the transmission of the plurality of first data packets because of a transmission to another receiver; wherein, according to the second case, the information is sent from the transmitter to the receiver when the transmitter interrupts the transmission of the plurality of first data packets for a transmission of first data packets of higher priority to the same receiver; wherein, according to the third case, the information is sent from the transmitter to the receiver when the transmitter interrupts the transmission of the plurality of first data packets for more than a preset time.

7. Data transmission system for transmitting data from a transmitter to a receiver, wherein the data is segmented into a plurality of first data packets for transmission, wherein the plurality of first data packets is provided with a transmission sequence number, wherein a retransmission for at least one second data packet of the plurality of first data packets is performed in case the at least one second data packet was unsuccessfully decoded at the receiver, the data transmission system comprising: a receiver; and a transmitter which is adapted for transmitting the data to the receiver; wherein the transmitter is adapted for transmitting a third data packet from the transmitter to the receiver including information with respect to the at least one second data packet; and wherein the information relates to which of the at least one second data packet is at least partly sent again from the transmitter to the receiver.

8. The data transmission system of claim 7, wherein the receiver is adapted to send a negative acknowledge message to the transmitter for each of the at least one second data packet which was unsuccessfully decoded at the receiver; wherein the transmitter is adapted to perform a retransmission for the at least one second data packet for which a negative acknowledgement message was received; wherein the transmitter is adapted to abort retransmission for the respective at least one second data packet after a preset number of unsuccessful retransmissions; and wherein the information indicates to the receiver at least one of a first fact and a second fact; wherein the first fact indicates for which of the at least one second data packet a negative acknowledgement message was received; and wherein the second fact indicates for which of the at least one second data packet which retransmission has been aborted, a new transmission is scheduled.

9. The data transmission system of claim 7, wherein the information is sent in one of a fourth, fifth and sixth data packet wherein the fourth data packet is scheduled next to be transmitted to the receiver; wherein the fifth third data packet is provided with a header; wherein the information is included in the header; wherein the sixth data packet does not include payload data and thus, has a short length.

10. Transmitter for transmitting data to a receiver, wherein the data is segmented into a plurality of first data packets for transmission, wherein the plurality of first data packets is provided with a transmission sequence number, wherein a retransmission for at least one second data packet of the plurality of first data packets is performed in case the at least one second data packet was unsuccessfully decoded at the receiver, wherein the transmitter is adapted to transmit a third data packet from the transmitter to the receiver including information with respect to the at least one second data packet; wherein the information relates to which of the at least one second data packet is at least partly sent again from the transmitter to the receiver.

11. The transmitter of claim 10, wherein the transmitter is adapted to perform a retransmission for the at least one second data packet for which a negative acknowledgement message was received; wherein the transmitter is adapted to abort retransmission for the respective at least one second data packet after a preset number of unsuccessful retransmissions; wherein the information indicates to the receiver at least one of a first fact and a second fact; wherein the first fact indicates for which of the at least one second data packet a negative acknowledgement message was received; and wherein the second fact indicates for which of the at least one second data packets which retransmission has been aborted, a new transmission is scheduled.

12. The transmitter of claim 10, wherein the transmitter is adapted to generate a list at the time of a generation of the information; wherein the list contains the at least one second data packet and a priority information or a channel information with respect to this at least one second data packet; and wherein the list is sent as the information

13. The transmitter of claim 10, wherein the transmitter is adapted to send the information in one of a fourth, fifth and sixth data packet; wherein the fourth data packet is scheduled next to be transmitted to the receiver; wherein the fifth third data packet is provided with a header; wherein the information is included in the header; wherein the sixth data packet does not include payload data and thus, has a short length.

14. The transmitter of claim 10, wherein the transmitter is adapted to send the information to the receiver in at least one of a first case, a second case and a third case; wherein, according to the first case, the information is sent from the transmitter to the receiver when the transmitter interrupts the transmission of the plurality of first data packets because of a transmission to another receiver; wherein, according to the second case, the information is sent from the transmitter to the receiver when the transmitter interrupts the transmission of the plurality of first data packets for a transmission of first data packets of higher priority to another receiver; wherein, according to the third case, the information is sent from the transmitter to the receiver when the transmitter interrupts the transmission of the plurality of first data packets for more than a preset time.

15. Receiver for receiving data transmitted from a transmitter, wherein the data is segmented into a plurality of first data packets for transmission, wherein the plurality of first data packets is provided with a transmission sequence number, wherein a retransmission for at least one second data packet of the plurality of first data packets is performed in case the at least one second data packet was unsuccessfully decoded at the receiver, wherein the receiver is adapted for receiving a third data packet from the transmitter including information with respect to the at least one second data packet; and wherein the information relates to which of the at least one second data packet is at least partly sent again from the transmitter to the receiver.

16. The receiver of claim 15, wherein the receiver sends a negative acknowledge message to the transmitter for each of the at least one second data packets which was unsuccessfully decoded at the receiver; wherein the information indicates to the receiver at least one of a first fact and a second fact; wherein the first fact indicates for which of the at least one second data packet a negative acknowledgement message was received; and wherein the second fact indicates for which of the at least one second data packet which retransmission has been aborted, a new transmission is scheduled.

17. The receiver of claim 15, wherein the receiver is adapted to receive and decode the information in one of a fourth, fifth and sixth data packet; wherein the fourth data packet is scheduled next to be transmitted to the receiver; wherein the fifth third data packet is provided with a header; wherein the information is included in the header; wherein the sixth data packet does not include payload data and thus, has a short length.

18. The receiver of claim 15, wherein the receiver comprises a reordering buffer; and wherein the receiver is adapted to, upon receipt of the information, purge in the reordering buffer all holes for seventh data packets of the plurality of first data packets for which no successful decoding has been performed except for the at least one second data packet indicated by the information.

19. Software program for controlling a data transmission between a transmitter and a receiver, wherein the data is segmented into a plurality of first data packets for transmission, wherein the plurality of first data packets is provided with a transmission sequence number, wherein a retransmission for at least one second data packet of the plurality of first data packets is performed in case the at least one second data packet was unsuccessfully decoded at the receiver, wherein the software program controls an operation of at least one of the transmitter and the receiver such that the following operation is performed: transmitting a third data packet from the transmitter to the receiver including information with respect to the at least one second data packet; and wherein the information relates to which of the at least one second data packets is at least partly sent again from the transmitter to the receiver.
